(19) United States
(12) Patent Application Publication
(10) Pub. No.: US 2013/0076475 A1
(43) Pub. Date: Mar. 28, 2013

(54) MAGNETIC CORE AND FORMING METHOD THEREOF

(71) Applicant: Takao IMAGAWA, Mito (JP)

(72) Inventor: Takao IMAGAWA, Mito (JP)

(73) Assignee: Hitachi, Ltd.

(21) Appl. No.: 13/589,351

(22) Filed: Aug. 20, 2012

(30) Foreign Application Priority Data
Sep. 28, 2011 (JP) 2011-211834

(51) Int. Cl. H01F 27/25; H01F 7/06

(52) U.S. Cl. 336/213; 29/605

(57) ABSTRACT

A simple forming method capable of reducing an eddy current loss in a magnetic core formed by winding a foil body is provided. A magnetic core formed by folding a foil strip in the longitudinal direction thereof, winding and laminating the folded strip starting from one folded end after folding into a cylindrical body, and exciting the cylindrical body in the lateral direction of the foil strip for use.

### CLAIM OF PRIORITY

The present application claims priority from Japanese Patent applications serial No.2011-211834, filed on Sep. 28, 2011, the respective contents of which are hereby incorporated by reference into this application.

### FIELD OF THE INVENTION

The present invention concerns a magnetic core for inductors, motors, etc. mainly utilizing an amorphous foil and a soft magnetic metal foil such as an electromagnetic steel sheet, as well as a method of forming the magnetic core.

### BACKGROUND OF THE INVENTION

In products using magnetic materials which require reduction of energy loss such as magnetic cores for reactor inductors, motors, etc. it is necessary that the magnetic core loss is small. When the magnetic core loss is decreased, small-sized inductors and motors with no heat generation can be attained, which provides much contribution to energy saving.

Considering a hysteresis loss caused by coercivity inherent to magnetic materials in magnetic core loss, amorphous, metal glass, etc. are adopted as magnetic materials of low coercivity. A technique of mainly using iron-based amorphous foils by a three-dimensional forming method has been studied since they have low coercivity and large saturation magnetization.

A technique of using an amorphous foil as a magnetic material and three dimensionally shaping the material to obtain a magnetic core is described, for example, in Japanese Patent Laid-Open No. 2005-184424, in which an amorphous foil is wound, and a solenoid coil is formed around the wound foil as an axis to form an inductor, or the wound amorphous foil is used as a wound magnetic core. Further, a motor magnetic core is formed in the wound shape as it is or further deformed so as to increase an occupation ratio.

In Japanese Patent Laid-Open No. 2011-29465, the magnetic permeability is controlled by cutting a portion of a ring of a wound amorphous foil thereby restricting the magnetization in the circumferential direction of the ring.

Further, Japanese Patent Laid-Open No. 2010-263233 proposes a method of manufacturing a magnetic core by forming one turn of a magnetic core with laminated amorphous strips and overlapping the ends of strips.

As has been described above, various techniques of using amorphous foils as the magnetic material and three-dimensionally shaping them to obtain a magnetic core have been known.

In the formation by the method of Japanese Patent Laid-Open No. 2005-184424 it has been formed that a load loss depending on the frequency is generated when an AC current is supplied to the coil and the loss greatly exceeds the hysteresis loss due to coercivity. Since the load loss shows a behavior in proportion to the square of the frequency which is identical, in appearance, with the eddy current loss, the loss is considered as the eddy current loss.

As a result of investigation for the cause and the countermeasure therefor, it was considered that a circular current flows in the wound magnetic core so as to offset the magnetic field generated in the coil. When a portion of the magnetic core is cut to notch a ring as proposed by Japanese Patent Laid-Open No. 2011-29465, the eddy current was not generated. That is, it appears as if the eddy current were generated through the insulated foils and the wound magnetic core operated as if it were an integral ring. It appears that the eddy current does not flow when the magnetic core is cut physically.

The method of Japanese Patent Laid-Open No. 2010-263233 was also effective for reducing the eddy current loss.

As described above, the method of Japanese Patent Laid-Open Nos. 2011-29465 and 2010-263233 were effective with a viewpoint of reducing the eddy current loss. However, they are not suitable to industrial mass production. Since it is demanded for inductors and motors concerned with the present invention that they are inexpensive in mass production, forming method of the magnetic core as described in Japanese Patent Laid-Open Nos. 2011-29465 and 2010-263233 is not practical. It is not considered in the patent documents that the amorphous material is hard and cutting operation therefor is extremely difficult.

Referring specifically, an amorphous material is hard compared with a crystalline metal material of iron and steel, etc. For example, when a cylinder of 22 mm outer diameter, 5 mm inner diameter, and 30 mm length of Japanese Patent Laid-Open No. 2011-29465 is formed and one side is cut by using a diamond cutter, the cutter has to be replaced during cutting operation on every about 10 pieces due to the consumption of the cutter blade. Further, it requires 10 minutes or more as a cutting time per one piece, which is not efficient. In addition, when water cooling is adopted for cutting, this also involves a drawback of causing rust to the amorphous material.

Japanese Patent Laid-Open No. 2010-263233 also involves an identical subject. For forming a cylinder of 22 mm outer diameter, 5 mm inner diameter, and 30 mm length as described above, it is necessary to divide a 12 m length foil of 25 thickness and 30 mm width into 4 cm length in average and wind the divided sheets by the number of 300. Although the amorphous foil can be cut, a blade has to be replaced upon manufacture of only several hundreds of magnetic cores even when a superhard material is used for the blade tip. Since the blade cost is added to the manufacturing cost, inexpensive production is difficult.

In view of the above, the present invention intends to provide a simple and convenient forming method capable of reducing the eddy current loss in a magnetic core by winding and forming a foil for use.

### SUMMARY OF THE INVENTION

In accordance with the invention, a magnetic core is provided by folding a foil strip in a longitudinal direction thereof, winding and laminating the folded foil starting from one end after folding to obtain a cylindrical body, and exciting the cylindrical body in the lateral direction of the foil strip.

In an embodiment, the foil strip is a metal magnetic foil strip comprising, for example, amorphous, metal glass, electromagnetic steel sheet, or permalloy.

In another embodiment, the fold length when folding the foil strip in the longitudinal direction is 100 (cm) or less.

In other embodiment, when a primary coil and a secondary coil are wound around the magnetic core and a current is applied to the primary coil, a ratio of a coercivity when an AC current at a predetermined frequency is applied to the primary coil to a coercivity when a DC current is applied to the primary coil is defined as a loss increase ratio, and the loss increase ratio is 2 or less.

In another aspect, the present invention provides a method of forming a magnetic core of folding a foil strip in the longitudinal direction thereof, bundling folded ends on one side after folding, and starting winding and lamination to obtain a cylindrical body.

In another embodiment, the cylindrical body after lamination was secured by a heat treatment.

In another embodiment, the cylindrical body after lamination, that is, the laminated cylindrical body is placed under pressure in a forming mold, and secured by a heat treatment into a predetermined shape.

In other embodiment, the laminated cylindrical body is placed under pressure in a forming mold, and secured by a varnish, an adhesive, etc. into a predetermined shape.

The present invention can provide inductors, highly efficient motors, etc. at a reduced cost and can contribute to the saving of resources and decrease in the energy.

### BRIEF DESCRIPTION OF THE DRAWINGS

FIG. 1 is a view for explaining the concept of fold winding according to the invention;

FIG. 2 is an explanatory view showing a method of measuring magnetic characteristics of a cylindrical magnetic core;

FIG. 3 is a graph showing magnetic characteristics obtained as a result of measurement for a cylindrical magnetic core G according to the invention;

FIG. 4 is a graph showing magnetic characteristics obtained as a result of measurement for the cylindrical magnetic core G according to an existent method; and

FIG. 5 is a graph showing a relation between a unit fold length and a loss increase ratio.

### DETAILED DESCRIPTION OF THE PREFERRED EMBODIMENTS

Preferred embodiments of the invention are to be described with reference to the drawings.

### First Embodiment

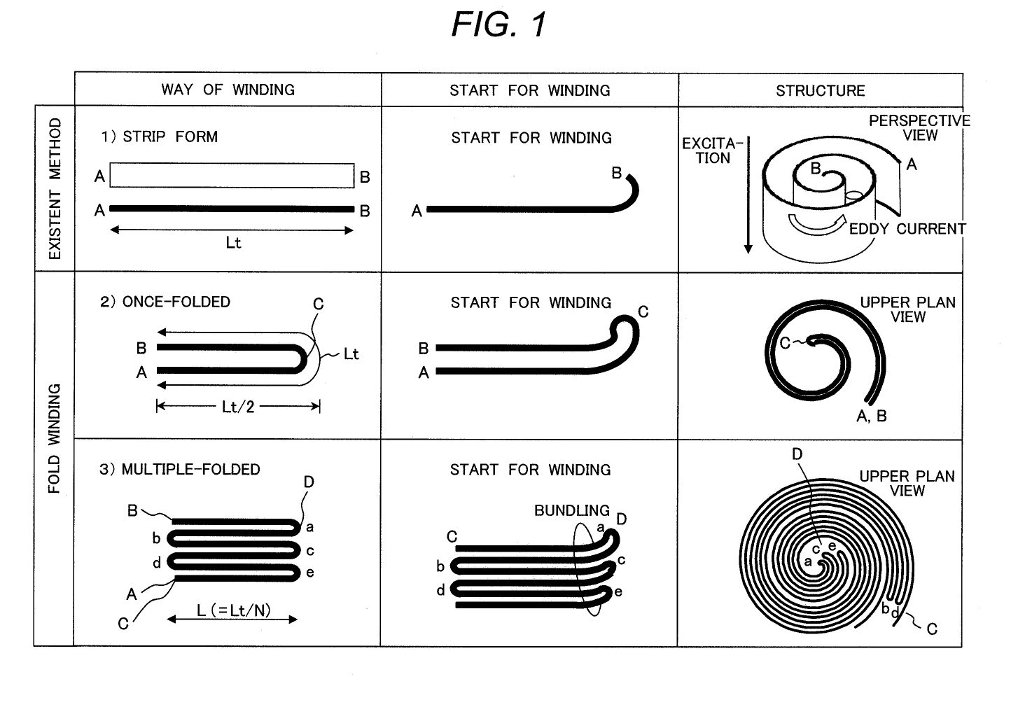

In the invention, a method of fold winding is adopted upon forming a magnetic core. The concept of the fold winding is at first described with reference to FIG. 1 in comparison with a usual existent winding method.

In FIG. 1, a winding method, a point for starting winding, and a structure after winding are illustrated from the left to the right in each of rows. Further, an example of the usual existent winding method and examples of the fold winding method according to the invention (two examples) are shown from the top to the bottom in each of columns. In each of the cases, a magnetic core is formed by using a strip member.

The strip member used herein is a member, as shown on the left in the upper row of FIG. 1, having a length Lt from an end A to an end B. In the usual existent winding, the strip member is wound starting from the end B and laminated successively and, finally, a magnetic core having a spiral cross section as shown on the right in the upper row is obtained. This is a so-called rolled paper-like cylindrical magnetic core.

On the contrary, in the fold winding of the invention, a strip member having a length Lt is overlapped by folding once or plural times and the overlapped strip member is wound. Such a way of winding of the invention is simply referred to as “fold winding”. In the example of once folding shown in the middle row, a strip member is bent to overlap the end B above the end A. Then, the once-folded material is laminated successively by winding starting from a new end C formed at the folded point and, finally, a magnetic core having a spiral cross section is obtained as shown on the right in the middle row. This is also a so-called rolled paper-like cylindrical magnetic core, in appearance, which is continuous with no cut in the midway.

In the example of multiple-fold winding shown in the lower row of FIG. 1, a strip member of a length Lt is folded by (N-1) times between the end A and the end B and divide the foil into N pieces. Accordingly, the length of the folded strip member is Lt/N in which a strip member having new ends C and D is obtained. The strip member folded by the number of (N-1) and having the new ends C and D is successively laminated by winding starting from the end D to finally obtain a magnetic core having a spiral cross section as shown on the right in the lowest row. This is also a cylindrical magnetic core in the so-called rolled paper like shape, in appearance, which is continuous with no cutting in the midway.

The wound magnetic core by fold winding or the fold wound magnetic core of the invention is formed as described above, and it is to be described below that desired magnetic core characteristics are obtained while showing specific material, shape (length, thickness, width), and the number of fold of the strip member.

In the invention, the folded strip member is once folded and then rolled up from one end. Accordingly, it is necessary that the strip member is thin like a foil and in a strip shape. Then, the strip member is sometimes referred to as a foil strip.

Further, a member formed by folding a strip member or a foil strip and further winding the same is sometimes referred to as a foil body since the member is formed of the foil.

It is necessary that the material of the strip member or the foil strip has flexibility and strength enough to withstand bending and an electromagnetic property as a magnetic core, and the type and the property of specific materials are to be described with reference to the following embodiments.

### Second Embodiment

### <Amorphous Foil Strip of 25 μm Thickness, 30 mm Width, 12 m Length, Fold Wound at 50 cm Length >

The material, shape (length, thickness, width), and the fold length of the strip member of the second embodiment are as described above. Since the amorphous foil strip is extremely thin, the strip can be wound starting from the end thereof even after it is folded by multiple times.

Specifically, each of the folded portions (shown by a, b, c, d, e in the lower row of FIG. 1) is adequately squashed upon folding, then the foil body is bundled by sandwiching the end D with a bobby pin, and the foil strip is wound around the pin at the end D as a center. The foil strip was wound while moderately holding a folded portion (end C) on the side opposite to the pin (end D) and determining the bending portion spontaneously along with progress of winding.

The fold wound magnetic core was a hollow magnetic core at a finished size of 23 mm diameter and 8 mm inner diameter. The end of the rolled amorphous foil body (end C) was secured to the main body by a tape.

Also for demonstrating the difference in the characteristics of the magnetic core of this embodiment from that obtained by the usual existent winding method, an existent magnetic core was also manufactured using the strip member by the winding method as shown in the upper row of FIG. 1. That is, an amorphous foil strip of 25 μm thickness, 30 mm width, and 6 m length was wound simply from one side (end B) to form a wound magnetic core. This was a hollow magnetic core of 22 mm outer diameter and 3 mm inner diameter. The cross sectional area was substantially identical with that of this embodiment.

### <Measurement for Magnetic Characteristics >

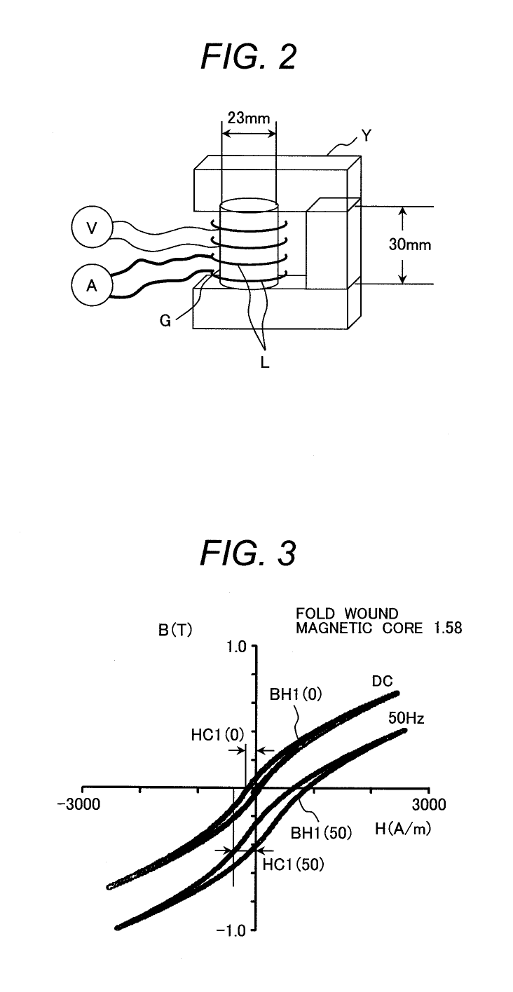

The would magnetic core prepared as described above is a cylindrical magnetic core like a rolled paper. The magnetic core of this shape is hereinafter referred to as a cylindrical magnetic core. In the measurement of magnetic characteristics, a coil L is wound around the cylindrical magnetic core G, and a yoke Y is attached while sandwiching upper and lower ends of the cylindrical magnetic core G as shown in FIG. 2.

Specifically, an insulation tape is wound around the cylindrical magnetic core G on which secondary coil and primary coil were wound around by 10T and 30T respectively. Coil layers were insulated from each other by a tape. Since the magnetic core length is as short as 30 mm, magnetic characteristics were measured by putting the magnetic core between the demagnetization field compensation yoke Y.

FIG. 3 shows magnetic characteristics obtained as a result of measurement for a cylindrical magnetic core G according to the invention. The magnetic characteristics are shown by so-called hysteresis loops (so-called B-H curve). The graph shows a curve BH1 (0) for a direct current at an applied magnetic field amplitude of 2500 A/m and a curve BH1 (50) for a 50 Hz AC current at an applied magnetic field amplitude of 2500 A/m.

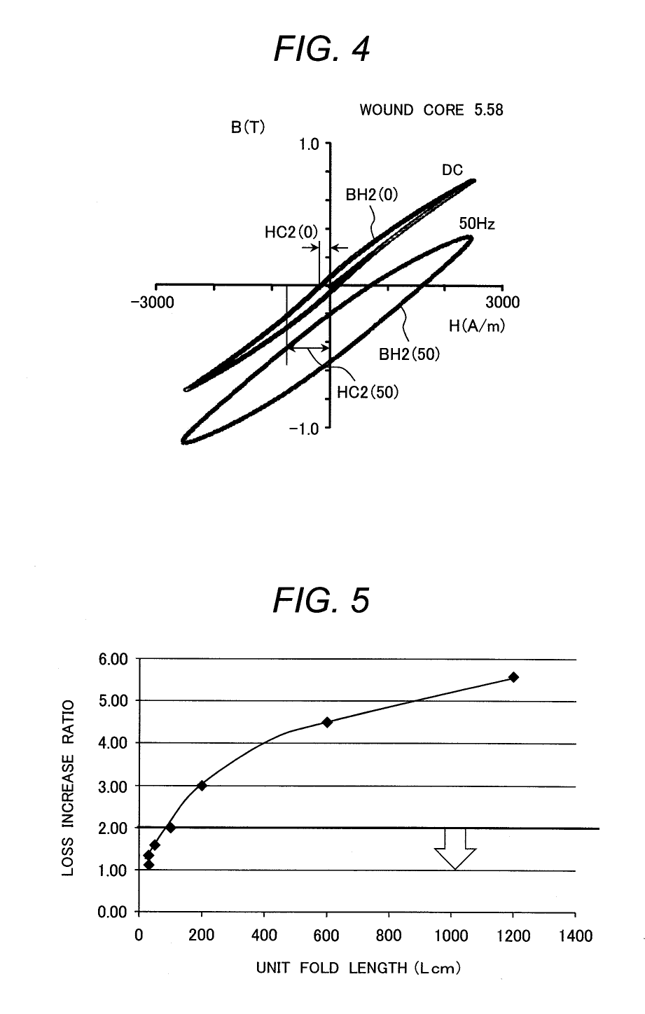

In the same manner, FIG. 4 shows magnetic characteristics obtained as a result of measurement for a cylindrical magnetic core G according to the existent method. The measuring conditions are identical with those in FIG. 3. The graph shows a curve BH2 (0) for a direct current at the applied magnetic field amplitude of 2500 A/m and a curve BH2 (50) for a 50 Hz AC current at the applied magnetic field amplitude of 2500 A/m.

When the characteristics are compared, in the fold wound magnetic core in FIG. 3, there is scarce difference between the curve BH1 (0) for the direct current and the curve BH1 (50) for the 50 Hz AC current. On the contrary, in the wound magnetic core in FIG. 4, a significant difference of the characteristics can be seen between the curve BH2 (0) for the direct current and the curve BH2 (50) for the 50 Hz AC current. Specifically, it can be seen that loss is increased in the curve BH2 (50) showing generation of the eddy current loss at the 50 Hz AC current.

Since comparison between the characteristics is difficult when the shape of the magnetic core varies, a parameter that represents the eddy current loss is defined. A ratio is defined between a current value corresponding to the coercivity for a direct current and a current value corresponding to the coercivity for a 50 Hz AC current at an identical exciting current. Specifically, coercivity Hc representing the eddy current loss is determined to the curve BH (0) for the direct current and the curve BH (50) for the 50 Hz AC current. Then, a ratio is determined assuming the coercivity Hc (0) for the DC current as a denominator and the coercivity Hc (50) for the 50 Hz AC current as a numerator, and this is defined as a loss increase ratio. Strictly, it is necessary to align the magnetic excitation level but only the value described above may suffice when judgment is focused on the presence or absence of the eddy current.

FIG. 3 shows the coercivity Hc1 (0) for the direct current and the coercivity Hc1 (50) for the 50 Hz AC current. Further, FIG. 4 shows the coercivity Hc2 (0) for the direct current and a coercivity Hc2 (50) for the 50 Hz AC current.

As a result of actual measurement, the loss increase ratio was 5.58 for the wound magnetic core by the existent method in FIG. 4 and it was 1.58 for the fold wound magnetic core according to the invention in FIG. 3. It can be said that generation of the eddy current loss is decreased as the value approaches 1.

Although it is more preferred that the value of the loss increase ratio is as close as 1, it is actually necessary to define an upper limit capable of withstanding the practical use. With the viewpoint above, an allowable value for the loss increase ratio was defined as 2.0 or less where the eddy current loss and the hysteresis loss are identical at 50 Hz.

In the present invention, the loss increase ratio was determined when the fold length was changed for the amorphous foil strip under the condition of the second embodiment (25 μm thickness, 30 mm width, 12 m length).

Table 1 shows the result. It is defined herein that the amorphous thickness is d (μm), the amorphous width is W (mm), the amorphous foil length is Lt (m), the amount of use is N, and the unit fold length is L (cm). The allowable value of the loss increase ratio was defined as 2.0 or less where the eddy current loss and hysteresis loss at 50 Hz are identical.

TABLE 1

| | | | | | Loss increase |
|---|---|---|---|---|---|
| d (μm) | W (mm) | Lt (m) | N | L (cm) | ratio |
| 25 | 30 | 12 | 1 | 30 | 1.33 |
| 25 | 30 | 12 | 1 | 50 | 1.58 |
| 25 | 30 | 12 | 1 | 100 | 2.01 |
| 25 | 30 | 12 | 1 | 200 | 2.99 |
| 25 | 30 | 12 | 1 | 600 | 4.50 |
| 25 | 30 | 12 | 1 | 1200 | 5.58 |
| 25 | 30 | 2 | 6 | 30 | 1.11 |

According to the result of Table 1, the loss increase ratio is 2.0 or less defined as the allowable value for the case of upper three ranks where the unit fold length L (cm) is 100 (cm) or less.

FIG. 5 shows the relation in Table 1 on a graph in which the abscissa denotes the fold unit (unit fold length L: cm) and the ordinate denotes the loss increase ratio. It was found that the loss increase ratio tends to be lower as the unit fold length is shortened. Further, it was important to determine the unit fold length as 100 (cm) or less for obtaining the ratio of 2.0 or less defined as the allowable value.

The difference of the effect is to be evaluated between the existent method and the method of the invention with the viewpoint of the loss increase ratio while changing the conditions such as the type, thickness d (μm), width W (mm), the length Lt (m), etc. of the strip member or foil strip.

### Third Embodiment]

### <Permalloy Foil Strip of 20 μm Thickness, 30 μm Width, 10 m Length, Fold Wound at 30 cm Length >

Since permalloy has a smooth surface and is liable to be in close contact to each other, it was wound while putting an insulation film of 25 μm thickness therebetween. The loss increase ratio was 6.20 in the simple winding and the loss increase ratio was 1.05 in the fold winding.

### Fourth Embodiment]

### <Electromagnetic Steel Strip of 200 μm Thickness, 5 mm Width, 3 m Length, Folded to 50 cm Length >

The loss increase ratio was 3.80 in the simple winding and the loss increase ratio was 1.22 in the fold winding.

### Fifth Embodiment]

### <Foil Strip of 40 μm Metal Glass Formed on a Polyimide Tape of 20 μm Thickness, 30 mm Width, 10 m Length, Fold Wound at 30 cm Length>

The loss increase ratio was 5.20 in the simple winding and the loss increase ratio was 1.55 in the fold winding.

### Sixth Embodiment]

### <Amorphous Foil Strip of 25 μm Thickness, 30 mm Width, 12 m Length, Fold Wound at 50 cm Length >

The fold wound magnetic core was subjected to a heat treatment in nitrogen at 380° C. for 3 hours under an applied magnetic field amplitude of 8,000 A/m in the longitudinal direction. After the heat treatment, the foil body lost flexibility and was secured. Coils were wound therearound at a ratio of secondary coils : primary coils of 10T :30T and magnetic characteristics were measured.

Compared with the case of not applying the heat treatment (second embodiment), the loss increase ratio was substantially identical as 1.29 and the coercivity was decreased by 20%.

Also for the electromagnetic steel sheet material, it was confirmed that the coercivity was decreased by 30% by applying a heat treatment at 800° C. for 3 hours and then performing measurement compared with that just after fold winding.

### Seventh Embodiment]

<Permalloy Foil Strip of 20 μm Thickness, 30 mm Width, 10 m Length, Fold Wound at 30 cm Length while Putting an Insulation Film of 25 μm Thickness Therebetween>

Then, it was secured by impregnating a varnish in vacuum. Coils were wound therearound at a ratio of a secondary coil and a primary coil of 10T:30T and magnetic characteristics were measured. The loss increase ratio was 1.15, which was substantially identical with the case of not applying impregnation.

### Eighth Embodiment]

### <Amorphous Foil Strip of 25 μm Thickness, 30 mm Width, 12 m Length, Fold Wound at 30 cm Length >

The foil strip was folded and wound in a circular shape and put as it was between shaping molds providing a trigonal cross sectional shape after forming and compressed under a pressure of 0.02 Gpa in a radial direction. When the molds were secured by screws after compression and heat treatment was applied together with the molds in nitrogen at 380° C. for three hours, it was confirmed that the trigonal cross sectional shape was maintained even after demolding. Coils were wound around the formed fold wound magnetic core at a ratio of secondary coil and a primary coil of 10T:30T and the magnetic characteristics were measured. While the loss increase ratio was somewhat lowered as 1.60 compared with that of the circular magnetic core, it did not exceed 2 and it was confirmed that the loss decreasing effect was not deteriorated also by fabrication.

### <Description for the Background Reaching the Invention and the Process of Investigation>

Since the eddy current loss is decreased in the structure of Japanese Unexamined Patent Application Publication No. 2011-29465, the present inventors have assumed as below.

At first, when the amorphous material is magnetized in-plane of a foil, since the thickness is as thin as 25 μm, it is not necessary to consider the eddy current generated in the cross section of the foil. This is because the sheet thickness of the electromagnetic steel sheet that causes a problem of the eddy current loss is 0.2 to 0.5 mm which is larger than that of the amorphous material, and because the specific resistivity of the amorphous material is 100 μΩ·cm which is five times or more of the electromagnetic steel sheet and the skin depth causing the surface effect is twice as large as that of the electromagnetic steel sheet, which is sufficiently large in view of the thickness of the foil body, so that there is no substantial problem of the loss.

Assuming a case of placing the foil as in the existent method shown in FIG. 1, winding the foil from the end and then standing it upright. When it is excited in the direction of an arrow shown by the structure of the existent method shown in FIG. 1, an induction current tends to flow along the foil in the direction of a fat arrow. If the ends A and B are in contact even partially, an induction current is generated. In the measuring system, measurement is performed while sandwiching a specimen by an yoke and reducing the demagnetization field as shown in FIG. 2. Since the yoke is made of a metal such as an electromagnetic steel sheet, short circuit may possibly be caused between the ends A and B through the yoke. Then, measurement was performed by putting insulation paper to the upper and lower ends of the magnetic core and the yoke, but the eddy current was still generated.

Referring to the eddy current in DC excitation, when insulation is applied between the foils, a voltage is generated between A and B, and the current stops after a while. When the direction of the magnetic field is reversed (negative direction), an opposite voltage is generated. Assuming a case where excitation is applied continuously in positive and negative directions. It is considered that since voltage changes between positive and negative directions at the ends and this voltage change appears as generation of the eddy current in accordance with the exciting magnetic field. When the frequency is low and the relaxation time is sufficiently short, only the voltage is generated but loss does not occur.

However, in a case of applying a high frequency, since the eddy current velocity is finite, it no more corresponds to the voltage change and a standing wave is generated between the ends. In this case, a constant current is generated to result the eddy current loss. Alternatively, when assuming a case where the peripheral length is longer, since the line is long, standing wave is generated even when the frequency is as low as about 50 Hz to result an eddy current loss. The wound magnetic core is in this state.

When one side of the magnetic core is cut through toward the central portion, since the cut faces form ends and the inter-end distance is sufficiently decreased, no eddy current loss is generated.

It is assumed a case where the foil is folded once and then wound as shown in the middle row of FIG. 1. While the total amount of the foil body is identical, since change at an identical potential is caused to the foils in parallel, voltage is generated at the folded portion as the end to form an effectively short foil body. As the number of fold increases as shown in the lower row of FIG. 1, the eddy current standing wave section is shortened correspondingly. When the inter-end distance is shortened, a magnetic core not causing the eddy current loss can be formed. Since the magnetic core is not cut, this can be manufactured inexpensively and rapidly. The magnetic core having such a feature is referred to as a wound magnetic core by fold winding, or a fold wound magnetic core.

When the amorphous material is an iron-based material, it can be used as a foil per se. Further, iron-based metal glass and cobalt-based amorphous material can be used as an extremely thin foil, or can be used by deposition to an organic material tape and used also as the fold wound magnetic core. The conditions for the materials are that they can be formed to a reduced thickness and have soft magnetic property. Accordingly, they are entirely referred to as a soft magnetic foil body or a soft magnetic foil strip.

What is claimed is:

1. A magnetic core formed for use by folding a foil strip in a longitudinal direction thereof, winding and laminating the folded foil strip starting from one end after folding into a cylindrical body, and exciting the cylindrical body in the lateral direction of the foil strip.

2. A magnetic core according to claim 1 wherein
the foil strip is a metal magnetic foil strip comprising amorphous, metal glass, electromagnetic steel sheet, or permalloy.

3. A magnetic core according to claim 1 wherein
the foil strip when folded in the longitudinal direction thereof has a fold length of 100 cm or less.

4. A magnetic core according to claim 1 wherein,
when a primary coil and a secondary coil are wound around the magnetic core and a DC current is applied to the primary coil, a ratio of a coercivity when an AC current at a predetermined frequency is applied to the primary coil to a coercivity when a DC current is applied to the primary coil is defined as a loss increase ratio, and the loss increase ratio is 2 or less.

5. A method of forming a magnetic core, comprising the steps of:
folding a foil strip in the longitudinal direction thereof;
bundling folded one end of the foil strip after folding; and
winding and laminating the folded foil strip to obtain a cylindrical body.

6. A method of forming a magnetic core according to claim 5, wherein
the foil strip is a metal magnetic foil strip comprising amorphous, metal glass, electromagnetic steel sheet, or permalloy.

7. A method of forming a magnetic core according to claim 5, wherein
the laminated cylindrical body after lamination is secured by a heat treatment.

8. A method of forming a magnetic core according to claim 5, wherein
the laminated cylindrical body after lamination is placed under pressure in a forming mold and secured by a heat treatment into a predetermined shape.

9. A method of forming a magnetic core according to claim 5, wherein
a laminated cylindrical body after lamination is placed under pressure into a forming mold and secured by a varnish, an adhesive, etc. into a predetermined shape.
